(19) United States
(12) Patent Application Publication
(10) Pub. No.: US 2025/0100928 A1
(43) Pub. Date: Mar. 27, 2025

(54) CEMENT REPLACEMENT MIXTURE

(71) Applicant: RESTONE AS, Stavanger (NO)

(72) Inventors: Jill Angelique CLAUSEN, Fyllingsdalen (NO); Eyvind TIME, Bryne (NO)

(21) Appl. No.: 18/728,748

(22) PCT Filed: Feb. 13, 2023
(86) PCT No.: PCT/NO2023/050032

§ 371 Date: Jul. 12, 2024

(30) Foreign Application Priority Data
Feb. 15, 2022 (NO) 20220205

(51) Int. Cl. C04B 14/04; C04B 14/06; C04B 28/02; C04B 40/00; C04B 103/00

(52) U.S. Cl. CPC C04B 14/042; C04B 14/062; C04B 28/02; C04B 40/0042; C04B 2103/0088

(57) ABSTRACT

The invention relates to a pozzolan mixture comprising between 5 and 80% of magnesium-iron solid solution silicates; between 5 and 80% of MgCOs X H20 where X=0-10; and between 2 and 30% of reactive silica; and having a free water content of at most 10% by total weight of mixture. The invention further relates to a method of making a cement slurry with a pozzolan mixture including the steps of: (i) reacting a magnesium-iron solid solution silicate with an acid and adding any extra magnesium-iron solid solution silicate to the products of the reaction to produce a pozzolan mixture comprising between 5 and 80% of magnesium-iron solid solution silicates: between 5 and 80% of MgCOs X H20, where X=0-10; between 2 and 30% of reactive silica: (ii) adding the products of step (i) to a slurry of cementitious material and water in a ratio of between 1:1.5 and 10:1 of cementitious material to the pozzolan mixture.

### FIELD OF THE INVENTION

The invention pertains to a pozzolan mixture and method of making a cement slurry with a pozzolan mixture.

### BACKGROUND OF THE INVENTION

Cementing contributes 6% of the world's annual anthropogenic CO₂ emissions. The cementing industry use Supplementary Cementitious Materials (SCMs) like Fly Ash (FA), amorphous silica and Ground Granulated Blast-furnace Slag (GGBS) to replace clinker, and to contribute to desirable traits, as well as to reduce the CO₂ footprint in the concrete products.

SCMs in the most commercial use today:
Fly ash (FA): From the burning of coal and furnace waste from energy production, (amorphous) silica waste extracted from filters in steel and solar cell production
GGBS (Ground Granulated Blast-furnace Slag): A by-product from the blast-furnaces used to make iron
Calcite/limestone fillers
Amorphous silica
Metakaoline, a calcinated clay product

While the actual CO₂ contribution is contended, particularly for FA and silica, some SCMs are resources declining in availability to the cementing industries. This is due to the decline in highly polluting practices that produce them (e.g. brown coal energy production). The cementing industries is looking for novel materials that can be used during and after the energy transition. Calcite filler is an example of such a material that is approved for used in parts of Europe, while a significantly lighter weight material (SG of 2.1-2.4 g/cm³) than clinker (CaO, SG of 3.1-3.3 g/cm³) used to produce the Portland Cement.

The magnesium-iron silicate olivine ((Mg,Fe)₂SiO₄) and its crystalline equivalents) is the most common mineral in earth, and such the resource potential is large for the cement and concrete industries. Olivine has a SG of 3.1-3.3 g/cm³, equivalent to that of clinker. Olivines can be used to sequester CO₂.

Serpentines describes the serpentine mineral group where the most commonly occurring minerals are antigorite, chrysotile, lizardite and have the generalized formula (Mg,Fe)₃Si₂O₅(OH)₄. Serpentines reacts with acids and will sequester CO₂. It will, however, not necessarily react to expand with water or expand at all, as the SG is already 2.7 g/cm³.

Minerals in the olivine group and the serpentine group may react with carbonic acid and/or CO₂(g,f,sc), to create new materials, including magnesite and brucite, in a type of process called carbonatization. The minerals that are produced when olivine and serpentine react may be less dissolvable once crystallized than for example calcite that is formed by carbonatization of CaO and CSH (cement clinker and the resulting minerals when Portland Cement is mixed in water).

Using a magnesium-iron solid-solution silicate as an additive in a cement mixture will reduce the CO₂ footprint of the cured product. First, replacing a portion of the cement clinker with a magnesium-iron solid solution silicate will avoid the CO₂ that would have been produced by that portion of cement. Additionally, a magnesium-iron solid solution silicate can sequester CO₂. It is desirable that an amount of the cement can be replaced with a magnesium-iron solid solution silicate without a reduction in strength of the cured product.

EP 2508496 A1 discloses a binder composition comprising magnesium oxide, a reactive SiO₂ and a hydrated magnesium carbonate of formula x MgCO3·y Mg(OH)2.·z H2O, wherein x≥1, the carbonate may be non-stoichiometric, and at least one of y or z≥0 and x, y, z may be integers or rational numbers, wherein the weight ratio of magnesia to hydromagnesite ranges from 1:20 to 20:1. The invention further relates to building materials made from the binder composition and to its use in construction.

Further prior art documents of interest may include WO 2021112684 A1, U.S. Pat. No. 5,194,087 A, and WO 2012028418 A1.

### DEFINITIONS

### Magnesium-Iron Solid Solution Silicates

The term “divalent magnesium-iron solid solution silicates” is a term of the art in geological and mineralogical sciences. A common short-hand term in the art is “magnesium-iron silicates”. In natural earth-based systems, there are more magnesium ions than iron ions present.

Magnesium-iron silicates have variable compositions due to “solid-solution” chemistry mainly involving Mg²⁺ and Fe²⁺ ions. These are silicate systems where iron and magnesium ions can occupy the same place in the mineral. This is called substitution and can occur over the complete range of possible compositions because iron and magnesium have a similar atomic radius (Fe⁺²=0.78 Å and Mg⁺²=0.72 Å) and can have the same valence state.

As an example, the formula for olivine is often given as: (Mg,Fe)₂SiO₄. To one skilled in the art, olivine can be thought of as a solid mixture of Mg₂SiO₄ (forsterite—Fo) and Fe₂SiO₄ (fayalite—Fa). If there is more forsterite than fayalite (thus more magnesium than iron), it can be referred to as a magnesium-iron silicate. If there was more fayalite than forsterite, then it can be referred to as an iron-magnesium silicate.

As another example, the formula for orthopyroxene is often given as: (Mg,Fe)₂Si₂O₆. To one skilled in the art, olivine can be thought of as a mixture of Mg₂Si₂O₆ (Enstatite—En) and Fe₂Si₂O₆ (Ferrosilite). Orthopyroxenes always have some Mg present in nature and pure Ferrosilite is only made artificially. Orthopyroxene with more Mg than Fe is referred to as a magnesium-iron silicate. If there was more ferrosilite than enstatite, then it can be referred to as an iron-magnesium silicate.

### Pozzolans

A pozzolan is classification for a group of compounds that have little or no cementitious value, which in the presence of water react chemically with calcium hydroxide (Ca(OH)₂) at room temperature to form compounds possessing cementitious properties. The quantification of the capacity of a pozzolan to react with calcium hydroxide and water is given by measuring its pozzolanic activity factor, k. Note that this “k factor” is an empiric value.

In order to be a cement-replacing material in the Portland cement system, the substance must also be a pozzolan. Cement replacing material that is currently used are FA, silica, rice husk, metakaolin and GGBS.

### Dry Mixture

In chemistry the term “dry” can be ambiguous. In one end of the scale anhydrous pertains to the absence of water, even in the crystal structure. Typical substances are calcined at high temperatures and shielded from moisture. On the other end is a slurry (enough water to make the mixture a liquid). Another concern when dealing with a magnesium-iron solid solution silicate is the fact that water can be trapped within the crystal matrix (i.e. crystal water, XH₂O). The water that is not bound in the matrix will be referred to as free water.

### Fillers

Fillers are materials whose function in concrete is based mainly on size and shape. They can interact with cementitious material blends in several ways:
to improve particle packing
give the fresh concrete novel properties
reduce the amount of cement in concrete without loss of strength

Ideally, fillers partially replace clinkers in the cement while improving the properties and the microstructure of the resulting concrete product.

Common fillers include quartz and limestone. Replacement of cement clinker by a filler will often lead to a more economical product and improve the properties of the cured concrete.

It is known that filler type and content have significant effects on fresh concrete properties where non-pozzolanic fillers reduce segregation and bleeding. Generally, the filler type and content have significant effects on concrete unit weight, water absorption and voids ratio. In addition, non-pozzolanic fillers have insignificant negative effects on concrete compressive strengths.

Fillers represent the finest grain fraction in aggregates for concrete and mortar where their grain sizes are less than 2 mm, and most of the grains pass 0.063 mm sieve (Defined in NS-EN 12620). The fraction with a grain diameter below 0.125 mm is called filler sand.

If the filler content becomes too large, the water demand increases for the blend, and reduced firmness and increased shrinkage of the concrete product may be the result.

### Objects of the Invention

Magnesium-iron solid solution silicates can absorb CO₂ through a carbonation process. The more traditional cementitious material that is replaced with magnesium-iron solid solution silicates, the more CO₂ that is absorbed. This absorption is at least partially due to the carbonation reaction.

Below is an example of a carbonation process of the magnesium end member olivine reacting with carbon dioxide.

Carbonation:

Mg₂SiO₄+2CO₂→2MgCO₃+SiO₂

The carbonation process example happens naturally, where CO₂ reacts with the forsterite endmember of the olivine solid solution series at temperatures above 300° C. (e.g. Greenschist facies). Not only does the above reaction absorb carbon dioxide, but it will fill the pores of the cement with new material. This gives a cement or cement mixture that contains a magnesium-iron solid solution silicate the ability to self-heal. The amount of CO₂ that can be captured is related to temperature, pressure, and grain size.

Thus, one of the objects of the present invention is to make a mixture, through chemical or physical means, in which a portion of the cementitious materials is replaced by a mixture with magnesium-iron solid solution silicates.

### Summary of the Invention

In some aspects, the techniques described herein relate to a synergetic pozzolan mixture comprising between 5 and 80%, preferably between 30 and 60%, of magnesium-iron solid solution silicates; between 5 and 80%, preferably between 30 and 60% of MgCO₃·X H₂O where X=0-10; and between 2 and 30%, preferably between 10 and 30%, of reactive silica; and having a free water content of at most 10% by total weight of mixture.

In some aspects, the techniques described herein relate to a pozzolan mixture comprising between 5 and 80% by weight, preferably between 30 and 60% by weight, of magnesium-iron solid solution silicates; between 5 and 80% by weight, preferably between 30 and 60% by weight, of MgCO₃·X H₂O where X=0-10; and between 2 and 30% by weight, preferably between 10 and 30% by weight, of reactive silica; and having a free water content of at most 10% by weight, based on the total mixture.

In some aspects, the techniques described herein relate to the pozzolan mixture as defined, wherein the reactive silica is amorphous silica.

In some aspects, the techniques described herein relate to the pozzolan mixture as defined, wherein the magnesium-iron solid solution silicate is selected from the group of minerals consisting of olivines, orthopyroxenes, amphiboles, and serpentines.

In some aspects, the techniques described herein relate to the pozzolan mixture as defined, wherein the magnesium-iron solid solution silicate is olivine.

In some aspects, the techniques described herein relate to the pozzolan mixture as defined, further including a cementitious material, and the ratio of the cementitious material to the pozzolan mixture is between 2:1 and 4:1.

In some aspects, the techniques described herein relate to the pozzolan mixture as defined, further including a cementitious material, and the weight ratio of the cementitious material to the pozzolan mixture is between 2:1 and 4:1.

In some aspects, the techniques described herein relate to the pozzolan mixture as defined, wherein the cementitious material is an alkaline cement.

In some aspects, the techniques described herein relate to the pozzolan mixture as defined, wherein the cementitious material is an alkali-activate binder.

In some aspects, the techniques described herein relate to the pozzolan mixture as defined, wherein the reactive silica is produced through one or more of the following: mechanical activation, temperature treatment, pressure treatment.

In some aspects, the techniques described herein relate to a method of making a cement slurry with a pozzolan mixture including the steps of: (i) reacting a magnesium-iron solid solution silicate with an acid and adding any extra magnesium-iron solid solution silicate to the products of the reaction to produce a pozzolan mixture, preferably a pozzolan dry mixture, comprising between 30 and 60% of magnesium-iron solid solution silicates; between 30 and 60% of MgCO₃·X H₂O where X=0-10; between 10 and 30% of reactive silica; (ii) adding the products of step (i) to a slurry of cementitious material and water in the ratio of between 1:1.5 and 10:1, suitably between 1.5:1 and 5:1, preferably between 2:1 and 4:1, of cementitious material to the pozzolan mixture.

In some aspects, the techniques described herein relate to a method of making a cement slurry with a pozzolan mixture including the steps of: (i) reacting a magnesium-iron solid solution silicate with an acid, preferably an acid containing a CO₃²⁻ion, and adding any extra magnesium-iron solid solution silicate to the products of the reaction to produce a pozzolan mixture, preferably a pozzolan dry mixture, comprising between 30 and 60% by weight of magnesium-iron solid solution silicates; between 30 and 60% by weight of MgCO₃·X H₂O where X=0-10; between 10 and 30% by weight of reactive silica; (ii) adding the products of step (i) to a slurry of cementitious material and water in weight ratio of between 1:1.5 and 10:1, suitably between 1.5:1 and 5:1, preferably between 2:1 and 4:1, of cementitious material to the pozzolan mixture.

In some aspects, the techniques described herein relate to the method as defined, wherein the reactive silica is produced by a reaction between the magnesium-iron solid solution silicate and an acid.

In some aspects, the techniques described herein relate to the method as defined, wherein the MgCO₃·X H₂O and the magnesium-iron solid solution silicate in the products are produced by a chemical reaction between the magnesium-iron solid solution silicates and H₂CO₃.

In some aspects, the techniques described herein relate to the method as defined, wherein all the MgCO₃·X H₂O in the products is produced by a chemical reaction between the magnesium-iron solid solution silicates and H₂CO₃.

In some aspects, the techniques described herein relate to the method as defined, wherein all of the MgCO₃·X H2O and all of the magnesium-iron solid solution silicates in the products are produced by a chemical reaction between the magnesium-iron solid solution silicates and H2CO₃.

In some aspects, the techniques described herein relate to the method as defined, wherein the acid is carbonic acid.

In some aspects, the techniques described herein relate to the method as defined, wherein the carbonic acid is produced by a reaction of CO₂ (g, l, sc) and water.

In some aspects, the techniques described herein relate to the method as defined, wherein the carbonic acid is produced by a reaction of a bicarbonate with an acid and/or water.

In some aspects, the techniques described herein relate to the method as defined, wherein the magnesium-iron solid solution silicate is selected from the group of minerals consisting of olivines, orthopyroxenes, amphiboles, and serpentines.

In some aspects, the techniques described herein relate to the method as defined, wherein the magnesium-iron solid solution silicate is olivine.

In some aspects, the techniques described herein relate to the method as defined, wherein the cementitious material is an alkaline cement.

In some aspects, the techniques described herein relate to the method as defined, wherein the cementitious material is an alkali-activate binder.

These and other objects and aspects of the invention will be described in further detail hereinafter.

### DETAILED DESCRIPTION OF THE INVENTION

Reference will now be made in detail to the present invention and embodiments thereof. Alternative embodiments will also be presented. This invention may, however, be embodied in many different forms and should not be construed as limited to the embodiments set forth herein. These embodiments are provided by way of illustration only. Several further embodiments, or combinations of the presented embodiments, will be within the scope of one skilled in the art.

Provided that magnesium-iron solid solution silicates are well known to not have significant pozzolanic properties, they are not thought as suitable to replace cementitious material in a dry mixture (that later be mixed with water to make a slurry with the desired pourability and strength characteristics).

We have discovered a synergetic pozzolanic effect of the combination of minerals:

Mg-Fe solid solution silicate+MgCO₃·X H₂O+silica

in a mixture of 5-80%, preferably 30-60%, of magnesium-iron solid solution silicates, between 5-80%, preferably 30-60%, of MgCO₃·X H₂O (hydromagnesite and magnesite), and between 2 and 30%, preferably between 10 and 30% of silica by total weight of the mixture. For a mixture that is suitable for sale in a bag of cement, it is preferable to have a free water content of at most 10% by total weight of the mixture. The mixture comprises the magnesium-iron solid solution silicates, MgCO₃·X H₂O (hydromagnesite and magnesite), silica and water in the above-mentioned percentages (%) which preferably are percentages by weight (% by weight). The free water content is preferably at most 10% by total weight of mixture, or at most 10% by weight, based on the total weight of the mixture. Preferably the free water content is at most 5% by weight. Ideally, the free water content is less than 1% by weight. These allow the produced mixture, to be a smooth mixture and that the water content is low enough that it does not have to be taken into consideration when making a slurry to a desired water to binder ratio.

In a dry mixture form, the silica will be amorphous silica (SiO₂). Amorphous silica is important as it already has a strong and documented pozzolanic effect (K) and may therefore work as a gel former in the cement.

When in a blended slurry, reactive silica refers to SiO₄⁴− (aq). Also, when in a slurry, it could refer to amorphous silica mass that is in the solid part of the solution (normally as undissolved precipitate).

The reactive silica can also be formed by a reaction between the magnesium-iron solid solution silicate and an acid to produce an SiO₄⁴⁻ ion. This can be done by reacting the magnesium-iron solid solution silicate with an acid or water (example shown is olivine):

Mg₂SiO₄+4 HA(aq)→2 MgA₂+SiO₄⁴⁻ (aq)+4 H⁺

A is the conjugate base (XOH^{x-}). The acid may be an organic acid such as formic acid or acetic acid. It can also be a strong acid such as HCl or H₂SO_{4.}

When the magnesium-iron solid solution silicate reacts with H₂CO₃ (aq) (i.e. carbonic acid), both the reactive silica and MgCO₃ is generated. This is preferable as only a single reaction is needed to produce the pozzolan mixture desired.

Mg₂SiO₄(s)+2H₂CO₃(aq)→2 MgCO₃(s)+H₄SiO₄(aq)→2 MgCO₃(s)+SiO₄⁴−(aq)+4 H⁺ (aq)

Note that since the carbonic acid dissociates in water, the above reaction can also be written as:

Mg₂SiO₄(s)+4H⁺(aq)+2CO₃⁻² (aq)→2 MgCO₃(s)+SiO₄⁴⁻(aq)+4H⁺(aq)

There are several ways to produce H₂CO₃. The preferred method is to react CO₂ with water:

CO₂+H₂O→H₂CO₃→2 H⁺+CO₃²−

This allows further absorption of CO₂ in addition to that from the process of curing cement that contains a magnesium-iron solid solution silicate.

Another way of producing H₂CO₃ is to react a bicarbonate with an acid (HCl is disclosed as an example of an acid):

CO₃²⁻+2 HCl→H₂CO₃+Cl₂(g)

Note that the chlorine gas produced is quickly reacted with the iron in the magnesium-iron solid solution silicate, so from a practical perspective the chlorine gas is not released to the atmosphere. Another way of producing H₂CO₃ is to react a bicarbonate with water:

CO₃²⁻+H₂O→H₂CO₃

Note that in the previous reactions of olivine to produce MgCO₃ and H₂CO₃ there are other products that are produced (for example H₂SiO₄) that are not relevant for understanding the pozzolanic mixture.

The above are examples pertaining to olivine. However, as magnesium-iron solid solution silicates are dominated by magnesium (Mg), their chemical reactions will be similar to the above. For example: the minerals olivine, orthopyroxenes, amphiboles, and serpentines are all desirable for this process. Our preferred magnesium-iron solid solution silicate is olivine.

The pozzolan mixture can replace between 10 and 70%, preferably between 20-50%, of cementitious mixture. This is a ratio, preferably weight ratio, of between 1.5:1 and 10:1, preferably between 1.5:1 and 4.5:1, most preferably between 2:1 and 4:1 of cementitious material to pozzolan mixture by weight of cementitious material. The properties of the finished product will be different for each of these ratios.

As it is desired that the cured cement has self-healing properties and absorption of CO₂ occurs even after the slurry is hardened, an excess of the magnesium-iron solid solution silicate is used for these blends.

### EXAMPLES

The invention is further illustrated in the following examples which, however, are not intended to limit the same. Parts, % and ratios relate to parts by weight, % by weight, and weight ratios, respectively, unless otherwise stated.

Multiple experiments were performed to assess the pozzolanic properties of a mixture of 41.3% olivine, 41.3% MgCO₃·4 H₂O, and 17.3% (reactive) SiO₂ was combined with cement and water. Samples with a cement to pozzolanic mixture ratio of between 2:1 and 4:1 were tested. The k factor, pozzolanic activity factor, was measured.

The total k factor for the mixture is given by the formula:

$${k}^{total} = \% olivine * {k}^{olivine} + \% {MgCO}_{3} \times {H}_{2} O * {k}^{MgCO 3 \cdot XH 2 O} + \% {SiO}_{2} * {k}^{SiO 2}$$

MgCO₃·4 H₂O is assumed to have a k factor of 0 and SiO₂ (amorphous silica) has a k factor of 2. Substitution of these factors into the above equation and solving for the k factor of olivine yields:

$${k}^{olivine} = ( {k}^{total} - 0.346 ) / 0.413$$

If we assume olivine and hydromagnesite both have a k factor of 0 then k^{total} should be 0.346. However, in this mixture, the total K factor was measured to be 0.625. This gives a k^{olivine}=0.675. This surprising result clearly shows that olivine in combination with MgCO₃·X H₂O and SiO₂ behaves synergistically as a pozzolan.

1. A pozzolan mixture comprising between 5 and 80% of magnesium-iron solid solution silicates; between 5 and 80% of MgCO₃·X H₂O where X=0-10; and between 2 and 30% of reactive silica; and having a free water content of at most 10% by total weight of mixture.

2. The mixture according to claim 1, wherein the mixture comprises between 30 and 60% of magnesium-iron solid solution silicates.

3. The mixture according to claim 1, wherein the mixture comprises between 30 and 60% of MgCO₃·X H₂O where X=0-10.

4. The mixture according to claim 1, wherein the mixture comprises between 10 and 30% of reactive silica.

5. The mixture according to claim 1, wherein the mixture has a free water content of at most 5% by total weight of mixture.

6. The mixture according to claim 1, wherein the mixture has a free water content of at most 1% by total weight of mixture.

7. The mixture according to claim 1, wherein the reactive silica is amorphous silica.

8. The mixture according to claim 1, wherein the magnesium-iron solid solution silicate is selected from the group of minerals consisting of olivines, orthopyroxenes, amphiboles, and serpentines.

9. The mixture according to claim 1, wherein the magnesium-iron solid solution silicate is olivine.

10. The mixture according to claim 1, further comprising a cementitious material, and the ratio of the cementitious material to the pozzolan mixture is between 1.5:1 and 5:1, preferably between 2:1 and 4:1.

11. The mixture according to claim 1, wherein the cementitious material is an alkaline cement.

12. The mixture according to claim 1, wherein the cementitious material is an alkali-activate binder.

13. The mixture according to claim 1, wherein the reactive silica is produced through one or more of the following: mechanical activation, temperature treatment, pressure treatment.

14. A method of making a cement slurry with a pozzolan mixture comprising the steps of:
(i) reacting a magnesium-iron solid solution silicate with an acid containing a CO₃²⁻ion and adding any extra magnesium-iron solid solution silicate to the products of the reaction to produce a pozzolan mixture comprising between 5 and 80% of magnesium-iron solid solution silicates; between 5 and 80% of MgCO3·X H₂O, where X=0-10; between 2 and 30% of reactive silica;
(ii) adding the products of step (i) to a slurry of cementitious material and water in a ratio of between 1:1.5 and 10:1 of cementitious material to the pozzolan mixture.

15. The method according to claim 14, wherein the mixture comprises between 30 and 60% of magnesium-iron solid solution silicates.

16. The method according to claim 14, wherein the mixture comprises between 30 and 60% of MgCO₃·X H₂O where X=0-10.

17. The method according to claim 14, where the mixture comprises between 10 and 30%, of reactive silica.

18. The method according to claim 14, comprising adding the products of step (i) to a slurry of cementitious material and water in a ratio of between 1.5:1 and 5:1, preferably between 2:1 and 4:1, of cementitious material to the pozzolan mixture.

19. The method according to claim 14, wherein the reactive silica is produced by a reaction between the magnesium-iron solid solution silicate and an acid.

20. The method according to claim 14, wherein the MgCO₃·X H₂O and the magnesium-iron solid solution silicate in the products are produced by a chemical reaction between the magnesium-iron solid solution silicates and H₂CO₃.

21. The method according to claim 14, wherein all the MgCO₃·X H₂O in the products is produced by a chemical reaction between the magnesium-iron solid solution silicates and H₂CO₃.

22. The method according to claim 14, wherein all of the MgCO₃·×H₂O and all of the magnesium-iron solid solution silicates in the products are produced by a chemical reaction between the magnesium-iron solid solution silicates and H₂CO₃.

23. The method according to claim 14, wherein the acid is carbonic acid.

24. The method according to claim 14, wherein the carbonic acid is produced by a reaction of CO₂ (g, l, sc) and water.

25. The method according to claim 14, wherein the carbonic acid is produced by a reaction of a bicarbonate with an acid and/or water.

26. The method according to claim 14, wherein the magnesium-iron solid solution silicate is selected from the group of minerals consisting of olivines, orthopyroxenes, amphiboles, and serpentines.

27. The method according to claim 14, wherein the magnesium-iron solid solution silicate is olivine.

28. The method according to claim 14, wherein the cementitious material is an alkaline cement.

29. The method according to claim 14, wherein the cementitious material is an alkali-activate binder.
